(19) United States
(12) Patent Application Publication
(10) Pub. No.: US 2008/0298931 A1
(43) Pub. Date: Dec. 4, 2008

(54) Q-Tote

(76) Inventor: William L Horner, Pulaski, TN (US)

Correspondence Address: Stanley Pierchoski, 28-B Public Square, Lawrenceburg, TN, 38464, US

(21) Appl. No.: 12/105,515

(22) Filed: Apr. 18, 2008

Related U.S. Application Data
(60) Provisional application No. 60/932,179, filed on May 30, 2007.

(51) Int. Cl. A01D 90/08

(52) U.S. Cl. 414/24.5

(57) ABSTRACT

A feeder carrying apparatus to carry a hay feeder may include a vertical flange to define a vertical channel for connecting to the hay feeder, a butt plate flange to define a butt plate channel being substantially perpendicular to the vertical flange, a spear tube connected to the vertical flange and adapted to accept a first spear. The butt plate channel may be adapted to accept a second spear and a distance between the butt plate flange and the spear tube may be adjustable to cooperate with the distance between the first spear and the second spear. The spear tube may include a tapered receiver, and the butt plate flange may include a center segment which is substantially perpendicular to the vertical flange. The butt plate flange may include an end segment which may be inclined inwards to cooperate with the curvature of the hay feeder, and the vertical flange may include apertures being positioned vertically along the vertical flange to mount the butt plate flange thereby adjusting the distance between the butt plate flange and the spear tube. The feeder carrying apparatus may include a support flange to connect the spear tube to the vertical flange, and the vertical flange may include a fastening device to fasten the feeder carrying apparatus between a first segment of the hay feeder and a second segment of the hay feeder.

### PRIORITY

The present invention claims priority based on 35 USC section 119 and based upon a provisional application with a Ser. No. 60/932,179 which was filed on May 30, 2007.

### FIELD OF THE INVENTION

This invention relates to a hay bale feeder feeder carrying apparatus and, more particularly, to a hay bale feeder feeder carrying apparatus having a device for accepting at least one screw spear for advancement into a feeder for a bale of hay.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

Hay is presently baled with a round shape. This is an efficient way of producing a hay bale because more material is baled in the same period of time than with the prior rectangular shaped bales, but it also produces a rather heavy and relatively large hay bale. For example, a round bale of hay may have a diameter of five feet with lengths of four feet, five feet, and seven and one-half feet, respectively, and maximum weights of about 1,400, 1,850, and 2,600 pounds, respectively. Of course, the type of hay such as clover or fescue, for example, and the amount of moisture has an effect on the weight of the bale.

Because of its size and weight, the round bale cannot be handled manually. Therefore, many farmers have allowed the hay to remain lying in the field where it has been baled until it is time to feed the animals. However, these bales are exposed to the rain, snow, and sun so that they tend to rot and deteriorate before they can be completely fed to the animals. This produces an average loss of about twenty per cent of the product.

Various types of apparatuses have previously been suggested to handle these large round hay bales so that they may be stored in a protected area to which they may be transported. Examples of such apparatuses are shown and described in U.S. Pat. No. 4,120,405 to Jones et al, U.S. Pat. No. 4,256,426 to Buss, U.S. Pat. No. 4,288,191 to Lynch, and U.S. Pat. No. 4,329,103 to Miller.

In the apparatus of the aforesaid Jones et al patent, for example, the round hay bale is penetrated by one long spear and two short spears. While the aforesaid Jones et al patent shows the long spear completely penetrating a round hay bale at its center and extending beyond the hay bale, the operation of the apparatus of the aforesaid Jones et al patent does not result in penetration of the hay bale to this extent. Instead, the long spear penetrates into the hay bale for approximately half of the length of the hay bale.

Additionally, the two short spears of the apparatus of the aforesaid Jones et al patent will penetrate the hay bale for only a short distance because the long spear only penetrates the hay bale for approximately half of its length. Therefore, most of the weight of the hay bale is supported by the single long spear of the apparatus of the aforesaid Jones et al patent.

Livestock feeders which are particularly adapted for the feeding of round or cylindrical hay bales are known in the art, such feeders being disclosed in U.S. Pat. No. 3,777,713 to R. A. Deats, U.S. Pat. No. 3,906,903 to L. C. Vanderwater, U.S. Pat. No. 4,302,139 to E. K. Malish and U.S. Pat. No. 4,706,609 to L. G. Delichte.

In general, each of these livestock feeders is of a cylindrical cage type, within which the round hay bale (which may be as much as five feet in diameter and weigh five hundred pounds) is supported directly on the ground or on a solid base member in a slightly elevated position off the ground. Supporting of the hay bale directly on the ground, or on a solid base member closely adjacent the ground, however, is disadvantageous for various reasons. For example, the hay bale tends to absorb moisture from the ground and/or the surrounding atmosphere, causing deterioration of the hay so that it becomes unfit for livestock consumption, resulting in possible losses of up to on the order of 30% of the hay or more in certain instances. This is particularly true in the winter when there is snow on the ground, or in the case of high water due to flooding. Such devices also tend to be unsanitary for these and other reasons.

These hay feeders may be fabricated from round tubing which allows the role of hay to be placed inside of the feeder, allowing the livestock to stick their heads through the tubing of the feeder in order to feed. Typically these feeders may be in two or three sections which are between 40 to 48 inches and are fastened together to form a substantially circular ring from 6 feet to 10 feet in diameter. One main purpose of these feeders is to allow the livestock to feed on the hay but to prevent the hay from being wasted which may result by preventing the hay from being stepped on and trampled into the dirt and mud. The ground surrounding the hay feeder may be moist which results in the hay feeder sinking into the ground. This increases the difficulty in relocating the hay feeder and may result in extensive manual labor and bending or breaking the tubular sections of the hay feeder.

The feeders for the bales of hay must be moved around from time to time in order to provide efficient use of the feeders. Needless to say, because of the large size of these feeders which is required to enclose the bale of hay, a mechanical device is usually required to facilitate the movement of these feeders. Furthermore, it would be desirable to be able to move these feeders with the same mechanized device that is used to move the bale of hay. Removing the device to move a bale of any and installing a second device to move the feeder is time-consuming and wasteful. Additionally, having two separate devices is inefficient and costly.

### SUMMARY

A feeder carrying apparatus to carry a hay feeder may include a vertical flange to define a vertical channel for connecting to the hay feeder, a butt plate flange to define a butt plate channel being substantially perpendicular to the vertical flange, a spear tube connected to the vertical flange and adapted to accept a first spear. The butt plate channel may be adapted to accept a second spear and a distance between the butt plate flange and the spear tube may be adjustable to cooperate with the distance between the first spear and the second spear.

The spear tube may include a tapered receiver, and the butt plate flange may include a center segment which is substantially perpendicular to the vertical flange.

The butt plate flange may include an end segment which may be inclined inwards to cooperate with the curvature of the hay feeder, and the vertical flange may include apertures being positioned vertically along the vertical flange to mount the butt plate flange thereby adjusting the distance between the butt plate flange and the spear tube.

The feeder carrying apparatus may include a support flange to connect the spear tube to the vertical flange, and the vertical flange may include a fastening device to fasten the feeder carrying apparatus between a first segment of the hay feeder and a second segment of the hay feeder.

### BRIEF DESCRIPTION OF THE DRAWINGS

The invention may be understood by reference to the following description taken in conjunction with the accompanying drawings, in which, like reference numerals identify like elements, and in which:

FIG. 1 is a front view of the feeder carrying apparatus attached to a hay bale feeder;

FIG. 2 is a side view of the feeder carrying apparatus attached to the hay bale feeder;

FIG. 3 illustrates a front view of the feeder carrying apparatus of the present invention;

FIG. 4 illustrates a side view of the feeder carrying apparatus of the present invention;

FIG. 5 illustrates a back view of the feeder carrying apparatus of the present invention;

FIG. 6 illustrates a top view of the feeder carrying apparatus of the present invention;

FIG. 7 illustrates a perspective view of the operation of the feeder carrying apparatus of the present invention;

FIG. 8 illustrates another perspective view of the operation of the feeder carrying apparatus of the present invention.

### DETAILED DESCRIPTION

The Q-Tote or feeder carrying apparatus 100 is an apparatus which may be detachably connected or be integral between the sections of the hay feeder 101 and allows any mechanism to pick up and relocate the feeder carrying apparatus 100 and hay feeder 101 by using any standard spear attachment. The feeder carrying apparatus 100 may be fastened between two sections of the feeder by bolts or by welding or other fastening devices. The feeder carrying apparatus 100 may receive the main spear from a standard farm spear and may include an apparatus to accept lower spears. The tractor or mechanism with the hay spear may hydraulically lift the hay feeder using the feeder carrying apparatus 100 as the point of attachment to the hay feeder.

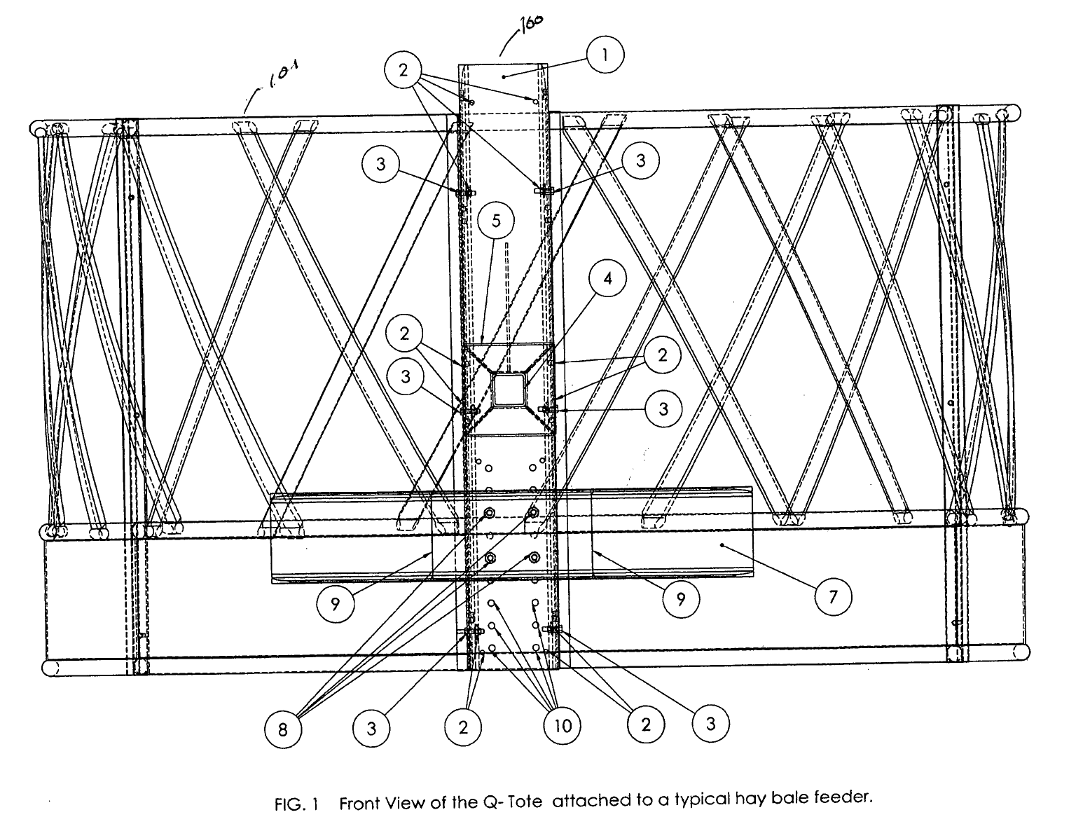

FIG. 1 illustrates the feeder carrying apparatus 100 connected between two sections of the hay feeder 101 by a fastening apparatus 3 which may be a bolt and bolt hole or other suitable fastening apparatus to detachedly connect the feeder carrying apparatus 100 to the hay feeder 101. Alternatively, the feeder carrying apparatus 100 may be welded between two sections of the hay feeder 101. FIG. 1 illustrates a vertical channel 1 which is defined by a vertical flange 2 which is formed from rigid material and which is shown as being substantially U-shaped. FIG. 1 shows the vertical flange 2 extending from substantially the bottom of the hay feeder 101 to over substantially the top of the hay feeder 101. FIG. 1 shows the sides of the vertical flange 2 fastened to a section of the hay feeder 101. The bottom surface or channel face 3 of the vertical flange 2 cooperates with spear tube 4 to accept a spear for moving the feeder carrying apparatus 100 and the hay feeder 101. The spear tube 4 includes a tapered receiver 5 having an inwardly inclined surfaces and an outer edge which cooperates with the bottom surface or channel face 3 of the vertical flange 2. The inwardly tapered surfaces of the tapered receiver 5 guide the spear into the interior of the spear tube 4.

FIG. 1 additionally illustrates a butt plate channel 7 which is defined by a butt plate flange 9 which is substantially U-shaped and formed from rigid material. The butt plate flange 9 traverses the vertical flange 2, and FIG. 1 shows the butt plate flange 9 substantially perpendicular to the vertical flange 2. The arms or sides of the vertical flange 2 extends inwards to allow the bottom of the butt plate flange 9 to be fastened to the bottom of the vertical flange 2 by the butt plate fastening device 8 which may be bolts. The distance between the spear tube 4 and the butt plate flange 9 can be varied or adjusted, particularly up-and-down by a series of apertures formed in the vertical direction in the bottom of the vertical flange 2. This will enable a tractor or lifting mechanism of different manufacturers having varying distances between the main spear and secondary spears to be accommodated.

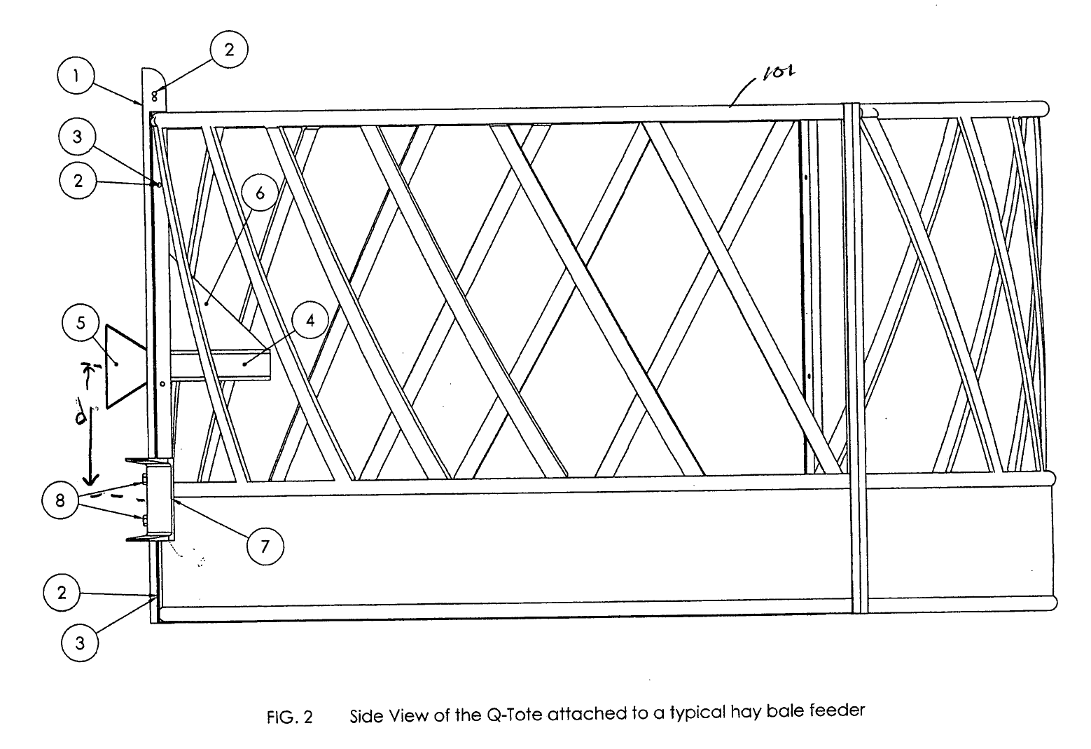

FIG. 2 illustrates a side view of the Q-Tote or feeder carrying apparatus and 100 connected to the hay feeder 101. FIG. 2 illustrates the side surface of the vertical flange 2 and the fastening device 3 which may be bolts and bolt holes. FIG. 2 additionally illustrates the spear tube 4 which includes the tapered receiver 5 which extends beyond the vertical flange 2. A support flange 6 extends between the top external surface of the spear tube 4 and the back surface of the vertical flange 2. The support flange 6 provide support to prevent movement of the spear tube 4 while the spear is being guided and lifting the hay feeder 101. FIG. 2 additionally illustrates the distance d between the butt plate flange 9 and the spear tube 4 which may be varied or adjusted by moving the butt plate flange 9 up or down and fastening the butt plate 9 to the support flange 2 the fastening device 8. The butt plate flange 9 is adapted to accept the lower or secondary spears 12 and the spear tube 4 is adapted to accept the primary or main spear 11.

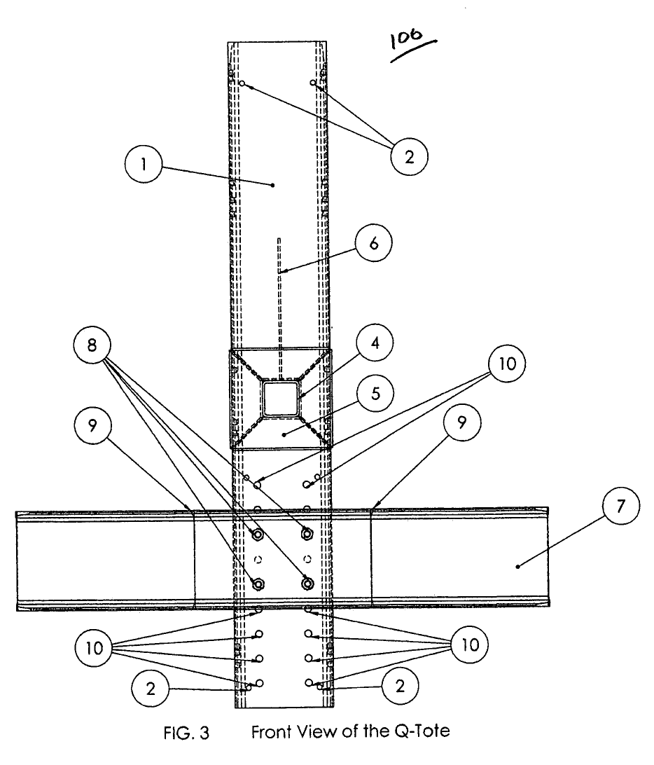

FIG. 3 illustrates a front view of the feeder carrying apparatus 100 of the present invention. The vertical flange 2 includes butt plate apertures 10 which extend along the bottom surface and near the edge of the vertical flange 2 substantially in the vertical direction. The butt plate apertures 10 cooperate with the butt plate fastening device 8 to secure and detachable connect the butt plate flange to the feeder carrying apparatus 100.

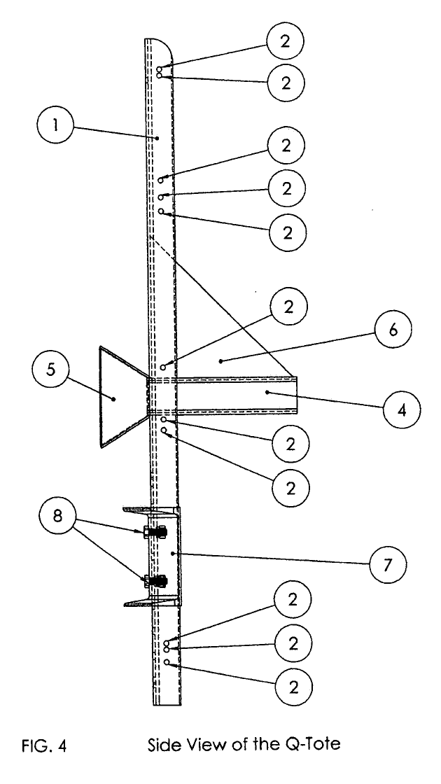

FIG. 4 illustrates apertures along the opposing sides of the vertical flange 2 so that the sections of the hay feeder 101 can be detachably connected to the feeder carrying apparatus 100. FIG. 4 additionally illustrates the butt plate fastening device 8 which is shown as bolts to secure the butt channel flange 9 to the vertical flange 2.

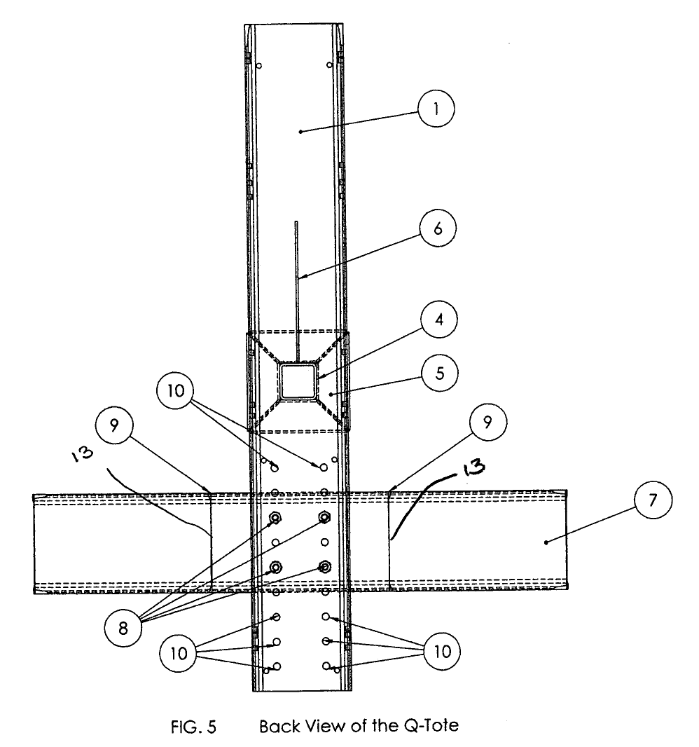

FIG. 5 illustrates a back view of the Q-Tote or feeder carrying apparatus 100 of the present invention. FIG. 5 shows the butt plate aperture 10 which extends through the vertical flange 2 and shows the fastening device 8 which FIG. 5 shows as bolts and nuts. FIG. 5 additionally illustrates a bend line 13 to indicate that the butt plate flange 9 is angled in which the butt plate flange 9 is substantially perpendicular to the vertical flange 2 at the center of the butt plate flange 9, but the butt plate flange 9 is angled inward at both ends of the butt plate flange 9 to the bend line 13 in order to cooperate with the curve of the hale bay feeder 101.

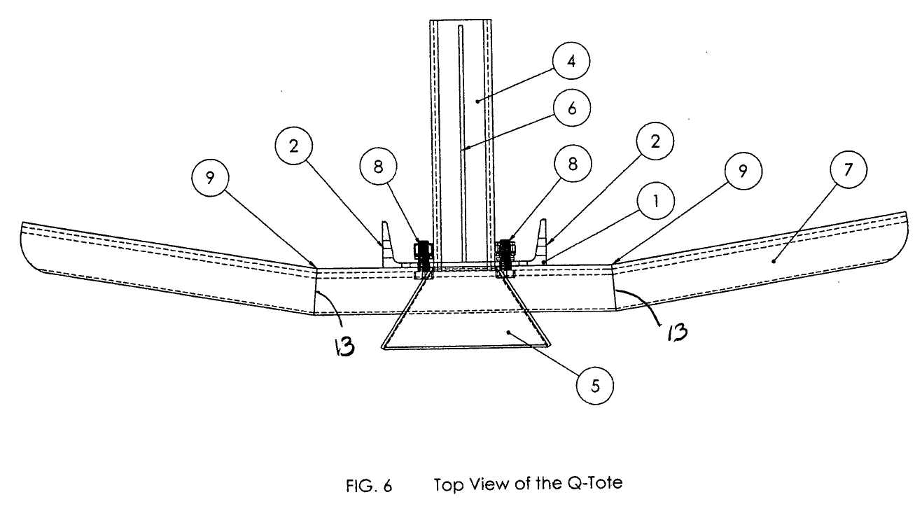

FIG. 6 illustrates a top view of the feeder carrying apparatus 100 and shows the center section of the butt plate flange 9 substantially perpendicular to the back surface of the vertical flange 2 and the end sections of the butt plate flange 9 being angled inwards at the bend line 13.

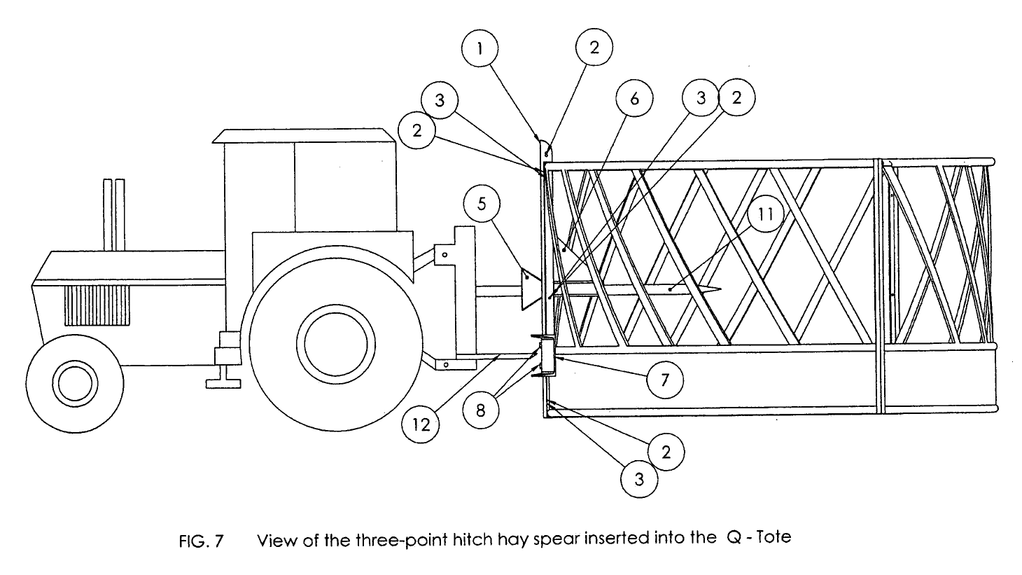

FIG. 7 illustrates a tractor which has a longer top main spear 11 and shorter lower spear(s) 12 to cooperate with the spear tube 4 and the butt plate flange 9, respectively. The present invention works equally well with one lower spear 12 or a multitude of lower spears 12. The main spear 11 will first enter the into interior of the spear tube 4 for a first predetermined distance and then the lower spear 11 enters the interior of the butt plate channel 7.

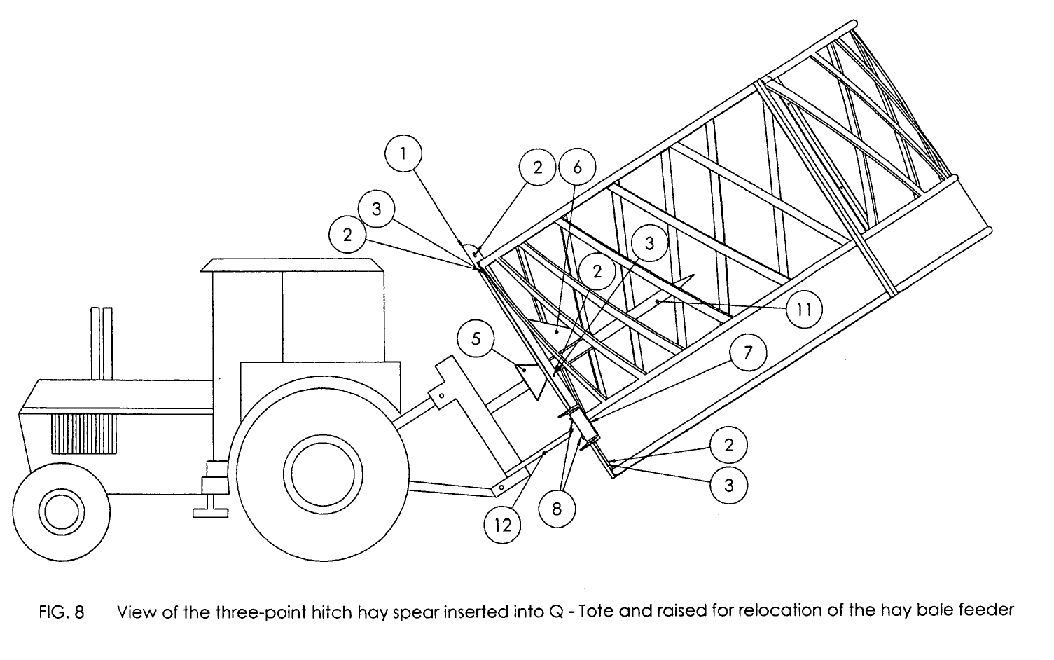

FIG. 8 illustrates that the tractor lifts the hay feeder 101 by the main spear 11 engaging the top interior surface of the tube spear 4, and substantially simultaneously the lower spear 12 engages the interior surface of the butt plate flange 9 to lift the hay feeder 101.

1. A feeder carrying apparatus to carry a hay feeder, comprising:
a vertical flange to define a vertical channel for connecting to the hay feeder;
a butt plate flange to define a butt plate channel being substantially perpendicular to the vertical flange;
a spear tube connected to the vertical flange and adapted to accept a first spear;
wherein the butt plate channel is adapted to accept a second spear and wherein a distance between the butt plate flange and the spear tube is adjustable to cooperate with the distance between the first spear and the second spear.

2. A feeder carrying apparatus to carry a hay feeder as in claim 1, wherein the spear tube includes a tapered receiver.

3. A feeder carrying apparatus to carry a hay feeder as in claim 1, wherein the butt plate flange includes a center segment which is substantially perpendicular to the vertical flange.

4. A feeder carrying apparatus to carry a hay feeder as in claim 1, wherein the butt plate flange includes an end segment which is inclined inwards to cooperate with the curvature of the hay feeder.

5. A feeder carrying apparatus to carry a hay feeder as in claim 1, wherein the vertical flange includes apertures being positioned vertically along the vertical flange to mount the butt plate flange thereby adjusting the distance between the butt plate flange and the spear tube.

6. A feeder carrying apparatus to carry a hay feeder as in claim 1, wherein the feeder carrying apparatus includes a support flange to connect the spear tube to the vertical flange.

7. A feeder carrying apparatus to carry a hay feeder as in claim 1, wherein the vertical flange includes a fastening device to fasten the feeder carrying apparatus between a first segment of the hay feeder and a second segment of the hay feeder.
